(19) United States
(12) Patent Application Publication
(10) Pub. No.: US 2024/0414665 A1
(43) Pub. Date: Dec. 12, 2024

(54) METHOD FOR F1AP AND NGAP CONDITIONAL EVENT REPORTING FOR TIMING RESILIENCE

(71) Applicant: Nokia Technologies Oy, Espoo (FI)

(72) Inventors: Pilar ANDRÉS MALDONADO, Aalborg (DK); Sean KELLEY, Naperville, IL (US); Devaki CHANDRAMOULI, Dallas, TX (US); David NAVRÁTIL, Espoo (FI)

(21) Appl. No.: 18/659,850

(22) Filed: May 9, 2024

Related U.S. Application Data
(60) Provisional application No. 63/501,859, filed on May 12, 2023.

(51) Int. Cl. H04W 56/00

(52) U.S. Cl. CPC H04W 56/001

(57) ABSTRACT

A network node, a core network node and a user equipment are disclosed. The network and the core network node each includes a processor; and a memory storing respective instructions. When executed by the processor, the network node is configured to: determine at least one radio access network timing synchronization status reporting range associated with at least one radio access network timing synchronization status attribute; and transmit, to a second network node, the radio access network timing synchronization status reporting range. The core network node is configured to: determine at least one radio access network timing synchronization status reporting range associated with at least one radio access network timing synchronization status attribute. In addition, the user equipment includes a processor; and a memory storing instructions that, when executed by the processor, cause the user equipment to: determine a clock quality acceptance criteria; and transmit the clock quality acceptance criteria.

### TECHNOLOGICAL FIELD

An example embodiment relates generally to techniques for conditional event reporting and, more particularly, to techniques for conditional event reporting of timing synchronization status.

### BACKGROUND

Within next generation radio access network architecture, F1 application protocol reporting can be configured between a central network entity and a distributed network entity in several ways. One time reporting can be configured in a request/response format. Event-triggered reporting can be configured upon a change of serving cell, change in a user equipment presence in an area of interest, or other significant events. Event-triggered reporting can also occur periodically, such as A2event-triggered periodic reporting in an MI reporting configuration. Continuous periodic reporting can also be configured based on a periodicity configured for providing reports to a consumer. An example of such reports is an inter-system resource status request. Next generation application protocol reporting between a network entity and an access and mobility management function (AMF) have similar report types.

Timing resilience can be enabled with 5GS network timing synchronization status and reporting. Timing synchronization status monitoring can be triggered by a user equipment subscription that includes clock quality information. Timing synchronization status monitoring can also be triggered by a request from an application function (AF) to subscribe to time synchronization service status for a target user equipment including clock quality information within the request. A service configuration for a network timing synchronization status subscription includes clock quality detail level and clock quality acceptance criteria. Clock quality detail level indicates whether and which clock quality information to provide to a user equipment. The values for clock quality detail level include “clock quality metrics” or “acceptable/not acceptable indication”. Clock quality acceptance criteria indicates acceptable criteria for a user equipment. Clock quality acceptance criteria is included if the “clock quality detail level” is equal to “acceptable/not acceptable.” The application function may provide clock quality detail level and clock quality acceptance criteria. Alternatively, clock quality detail level and clock quality acceptance criteria can be part of the user equipment's subscription. If an application function provides these values, the same reporting configured to the user equipment (e.g., clock quality metrics or acceptable/not acceptable timing synchronization service) is notified to the application function requesting the service.

To determine timing synchronization status in a core, a time sensitive communication and time synchronization function (TSCTSF) subscribes to a radio access network (RAN) timing synchronizations status (TSS). The subscription can be through an access and mobility management function or through operations, administration, and maintenance. A radio access network timing synchronization status can be reported from a next generation radio access network node to the time sensitive communication and time synchronization function through the access and mobility management function. The radio access network timing synchronization status can be reported from the next generation radio access node to the subscribed user equipment to the service if the user equipment context stored at the next generation radio access network node indicates it.

Timing synchronization information may contain different attributes in the form of information elements. A synchronization state information element indicates the state of a node synchronization represented by values “Locked”, “Holdover”, or “Freerun”. A clock quality information element may be used. A traceable to global navigation satellite system information element indicates whether the current time source is traceable to the global navigation satellite system and is represented by values “Yes” or “No”. A traceable to coordinated universal time information element indicates whether the current time source is traceable to the coordinated universal time and is represented by values “Yes” or “No”. A frequency stability information element describes an estimate of the variation of a local clock when it is not synchronized to another source. A precision time protocol (PTP) clockClass information element is available under nodes are synchronized using (g) PTP. A clock accuracy information element describes a mean in nanoseconds over an ensemble of time measurements between a clock under test and a reference clock. A parent time source information element describes the primary source the node is currently using and can be represented by values “PTP”, “GNSS”, “atomic clock”, “terrestrial radio”, “serial time code”, “NTP”, “hand_set”, and “other”.

A next generation radio access network can be pre-configured with thresholds for each of the attributes listed above. When a radio access network timing synchronization status exceeds a threshold (status degradation) or when the radio access network timing synchronization status meets the thresholds again (status improvement), a radio access network node generates a radio access network timing synchronization report. The radio access network node notifies the time sensitive communication and time synchronization function using either N2 node level signaling via an access and mobility management function or via operations, administration, and maintenance. The radio access network node notifies the user equipment devices via broadcast notification using SIB 9 and dedicated radio resource control signaling of the user equipment is in RRC_CONNECTED.

Reporting towards a user equipment can indicate a clock quality acceptance criteria, which describes a condition for acceptable or not acceptable service operation for a user equipment. Evaluation of clock quality acceptance criteria may be performed by a distributed network entity if clock quality acceptance criteria is received from a central network entity. Evaluation of clock quality acceptance criteria can also be performed by a central network entity if clock quality metrics are received from a distributed network entity.

Information flow is used to control timing synchronization status reporting towards a user equipment and a time sensitive communication and time synchronization function. For non-user equipment associated signaling, a procedure can be used for signaling radio access node timing synchronization status or core network timing synchronization status to an application function which subscribed to a time sensitive communication and time synchronization function for network timing synchronization status. Information flow between an application function and a time sensitive communication and time synchronization function can be used to signal target user equipment identifiers and subscription to network status (e.g., providing a list of timing synchronization status attributes). Information flow between a time sensitive communication and time synchronization function and an access and mobility management function, between an access and mobility management function and a central unit of gNB (gNB-CU), and between a central unit of gNB and a distributed unit of gNB (gNB-DU) can be used to signal a timing synchronization status attributes list. For user equipment associated signaling, a procedure can be used for signaling time synchronization service for clock quality reporting to user equipment and application functions. Information flow between an application function and a time sensitive communication and time synchronization function, between a time sensitive communication and time synchronization function and an access and mobility management function, and between an access and mobility management function and a central unit of gNB can be used to signal target user equipment identifier, clock quality detail level, and clock quality acceptance criteria.

Timing synchronization status thresholds for the gNB are pre-configured by an operator and are the same in different radio access network nodes. The thresholds are relevant for service requirements at operator configuration and are assumed to be the smallest values of any potential timing synchronization service later requested for a user equipment. A central unit of gNB needs to know the timing synchronization status to report to a subscribed time sensitive communication and time synchronization function via an access and mobility management function. The central unit also reports the timing synchronization status to user equipment devices following the acceptance criteria. However, a distributed unit does not require the user equipment specific acceptance criteria. The distributed unit of gNB requires the thresholds to report the radio access network timing synchronization status (node level information) to the central unit gNB. In a case of continuous degradation or improvement, a gNB's thresholds can start or stop node level reporting between a central unit of gNB and a distributed unit of gNB. For enumerated attributes such as synchronization state, event based reporting in F1 application protocol and next generation application protocol may be used in which a report is generated and sent when there is a change in value. However, for non-enumerated attributes, there is no way to ensure that a central unit of gNB is aware of a timing synchronization status at the distributed unit of gNB to determine if the service is acceptable or unacceptable for a user equipment or to keep a time sensitive communication and time synchronization function updated with latest status degradations or improvements via an access and mobility management function using next generation application protocol reporting between a central unit of gNB and an access and mobility management function, unless a report is generated upon every change in value which creates an unnecessary large volume of reports. Event triggered reporting when the timing synchronization status is met can't capture a user equipment's clock quality acceptance criteria.

### BRIEF SUMMARY

A method, apparatus, and computer program product are provided for conditional event reporting.

In an example embodiment, a network node is provided that includes at least one processor and at least one memory including computer program code with the at least one memory and the computer program code configured to, with the at least one processor, cause the network node to determine at least one radio access network timing synchronization status reporting range associated with at least one radio access network timing synchronization status attribute. The at least one memory and the computer program code are further configured to, with the at least one processor, cause the network node to transmit, to a second network node, the radio access network timing synchronization status reporting range.

In an example embodiment, a core network node is provided that includes at least one processor and at least one memory including computer program code with the at least one memory and the computer program code configured to, with the at least one processor, cause the core network node to determine at least one radio access network timing synchronization status reporting range associated with at least one radio access network timing synchronization status attribute.

In an example embodiment, a user equipment is provided that includes at least one processor and at least one memory including computer program code with the at least one memory and the computer program code configured to, with the at least one processor, cause the user equipment to determine a clock quality acceptance criteria. The at least one memory and the computer program code are further configured to, with the at least one processor, cause the user equipment to transmit the clock quality acceptance criteria.

In an example embodiment, a method is provided that includes determining, by a network node, at least one radio access network timing synchronization status reporting range associated with at least one radio access network timing synchronization status attribute. The method further includes transmitting, to a second network node, the radio access network timing synchronization status reporting range.

In an example embodiment, a method is provided that includes determining, by a core network node, at least one radio access network timing synchronization status reporting range associated with at least one radio access network timing synchronization status attribute.

In an example embodiment, a method is provided that includes determining, by a user equipment, a clock quality acceptance criteria. The method further includes transmitting the clock quality acceptance criteria.

In an example embodiment, a non-transitory computer readable storage medium is provided including computer instructions that, when executed by a network node, cause the network node to at least determine at least one radio access network timing synchronization status reporting range associated with at least one radio access network timing synchronization status attribute. The non-transitory computer readable storage medium further includes computer instructions configured, upon execution, to transmit, to a second network node, the radio access network timing synchronization status reporting range.

In an example embodiment, a non-transitory computer readable storage medium is provided including computer instructions that, when executed by a core network node, cause the core network node to at least determine at least one radio access network timing synchronization status reporting range associated with at least one radio access network timing synchronization status attribute.

In an example embodiment, a non-transitory computer readable storage medium is provided including computer instructions that, when executed by a user equipment, cause the user equipment to at least determine a clock quality acceptance criteria The non-transitory computer readable storage medium further includes computer instructions configured, upon execution, to transmit the clock quality acceptance criteria.

In an example embodiment, a network node is provided that includes means for determining at least one radio access network timing synchronization status reporting range associated with at least one radio access network timing synchronization status attribute. The network node further includes means for transmitting, to a second network node, the radio access network timing synchronization status reporting range.

In an example embodiment, a core network node is provided that includes means for determining at least one radio access network timing synchronization status reporting range associated with at least one radio access network timing synchronization status attribute.

In an example embodiment, a user equipment is provided that includes means for determining a clock quality acceptance criteria. The user equipment further includes means for transmitting the clock quality acceptance criteria.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system including user equipment, a central network entity, a distributed network entity, and a core network entity in accordance with an example embodiment of the present disclosure;

FIG. 2 is a block diagram of an example communication system in which the system of FIG. 1 may be deployed in accordance with an example embodiment of the present disclosure;

FIG. 3 is an example of radio access network timing synchronization status thresholds and clock quality acceptance criteria in accordance with previous embodiments;

FIG. 4A-4B are example reports configured by a distributed network entity in accordance with previous embodiments;

FIG. 5 is an example report based on a timing synchronization status reporting range in accordance with an example embodiment;

FIG. 6 is a flow diagram demonstrating operations performed by a central network entity and a distributed network entity to request reporting based on reporting ranges in accordance with an example embodiment;

FIG. 7 is a flow diagram demonstrating operations performed in conditional event reporting in accordance with an example embodiment;

FIG. 8 is a flow diagram demonstrating operations performed in conditional event reporting when a user equipment signals clock quality acceptance criteria in accordance with an example embodiment;

FIG. 9 is a flow diagram demonstrating operations performed in conditional event reporting when a network entity determines reporting ranges based on acceptance criteria in accordance with an example embodiment;

FIG. 10 is a table demonstrating an integer encoding of a radio access network timing synchronization status attribute in accordance with an example embodiment;

FIG. 11 is a flowchart demonstrating the operations performed, such as by the apparatus of FIG. 2, in order to transmit a reporting range in accordance with an example embodiment;

FIG. 12 is a flowchart demonstrating the operations performed, such as by the apparatus of FIG. 2, in order to determine a reporting range in accordance with an example embodiment; and

FIG. 13 a flowchart demonstrating the operations performed, such as by the apparatus of FIG. 2, in order to transmit clock quality acceptance criteria in accordance with an example embodiment.

### DETAILED DESCRIPTION

Some embodiments of the present disclosure will now be described more fully hereinafter with reference to the accompanying drawings, in which some, but not all, embodiments are shown. Indeed, various embodiments may be embodied in many different forms and not to be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms not to be taken to limit the spirit and scope of embodiments of the present disclosure.

Additionally, as used herein, the term “circuitry” refers to (a) hardware-only circuit implementations (e.g., implementations in analog circuitry and/or digital circuitry); (b) combinations of circuits and computer program product(s) including software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation including one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encored thereon computer-executable instructions or software programs. A non-transitory “computer readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal synchronous bus (USB) flash drives), computer system memory or random-access memory (such as dynamic random access memory (DRAM), static random access memory (SRAM), extended data out random access memory (EDO RAM), and the like.

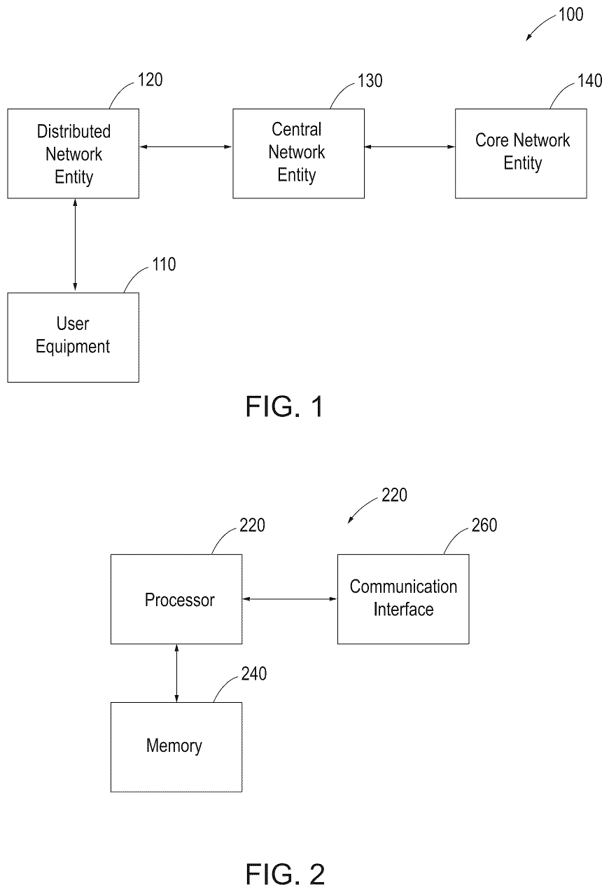

As illustrated in FIG. 1, a system 100 is provided in accordance with an example embodiment in order to perform event reporting. Although the system may be configured in various manners, the system of one embodiment is depicted in FIG. 1 and includes user equipment 110, distributed network entity 120, central network entity 130, and core network entity 140 configured to communicate via at least uplink and downlink transmission and reception beams. Although one user equipment, two network entities, and one core network entity is depicted, the system may include and the user equipment 110, distributed network entity 120, central network entity 130, and core network entity 140 may communicate with additional user equipment, network entities, and core network entities in other embodiments. In one or more embodiments, the user equipment 110, distributed network entity 120, central network entity 130, and core network entity 140 may configured to support, for example, 5G, 5G advanced, or 6G. In one or more embodiments, the system 100 may support carrier aggregation and/or dual connectivity. As described below, the system is configured to transmit a variety of requests, signals, and reports. In one or more embodiments, timing synchronization status thresholds and reporting ranges are transmitted between the user equipment 110, distributed network entity 120, and central network entity 140.

The data that is transmitted between the user equipment 110, distributed network entity 120, central network entity 130, and the core network entity 140 can be any of a wide variety of data including, but not limited to digital imagery data including video data, audio data as well as data provided by sensors, radars, telescopes and radio receivers. In at least some instances, the data is encoded prior to communication of the data via the uplink and downlink beams and decoded upon reception. The resulting data received may be utilized for a variety of purposes including presentation to a user, storage of the data for subsequent use and/or provision of the data to one or more applications, such as applications that perform statistical inference on the data for various purposes including object recognition, image classification, spectrum sensing, speech transcription and/or prediction or detection of events.

The user equipment 110 of FIG. 1 (also called UE, user device, user terminal, terminal device, etc.) illustrates a type of an apparatus which resources on an air interface are allocated and assigned. The user equipment 110 typically refers to a portable computing device that includes wireless mobile communication devices operating with or without a subscriber identification module (SIM), including, but not limited to, the following types of devices: a mobile station (mobile phone), smartphone, personal digital assistance (PDA), handset, device using a wireless modem (alarm or measurement device, etc.), laptop and/or touch screen computer, tablet, game console, notebook, and multimedia device. User equipment 110 may also be a device having capability to operate in Internet of Things (IoT) network which is a scenario in which objects are provided with the ability to transfer data over a network without requiring human-to-human or human-to-computer interaction. User equipment 110 is configured to perform one or more of user equipment functionalities. The user equipment 110 may also be called a subscriber unit, mobile station, remote terminal, access terminal, user terminal, or user equipment (UE) just to mention but a few names or apparatuses.

The distributed network entity 120 and the central network entity 130 of FIG. 1 may comprise, for example, base stations such as remote radio heads (RRHs), transmission reception points (TRPs), access points, node Bs (e.g., gNB) or other transmission sources. The distributed network entity 120 and the central network entity 130 may be configured to communicate with user equipment 110 via a network.

The core network entity 140 may comprise any of an access and mobility management function (AMF), a time sensitive communication and time synchronization function (TSCTSF), an application function (AF), or the like. Core network entity 140 may be configured to communicate with any of user equipment 110, distributed network entity 120, and central network entity 130.

FIG. 2 depicts an example apparatus 200 that may be configured to function as user equipment 120 or NG-RAN node 140. As shown in FIG. 2, the apparatus includes, is associated with, or is in communications with processing circuitry 220, a memory 240, and a communication interface 260. The processing circuitry 220 may be in communication with the memory device 240 via a bus for passing information among components of the apparatus. The memory device may be non-transitory and may include, for example, one or more volatile and/or non-volatile memories. In other words, for example, the memory device may be an electronic storage device (e.g., a computer readable storage medium) including gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices described as above. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 220, also referenced as a processor, may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining, and/or multithreading.

In an example embodiment, the processing circuitry 220 may be configured to execute instructions stored in the memory device 240 or otherwise accessible to the processing circuitry. Alternatively or additionally, the processing circuitry may be configured to execute hardcoded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 260 may be any means such as a device or circuitry embodied in either hardware or a combination of hardware and software that is configured to receive and/or transmit data including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communications interface may alternatively or also support wired communication. As such, for example, the communication interface may include a communication modem and/or other hardware/software for supporting communication via cable, digital subscriber line (DSL), universal serial bus (USB) or other mechanisms.

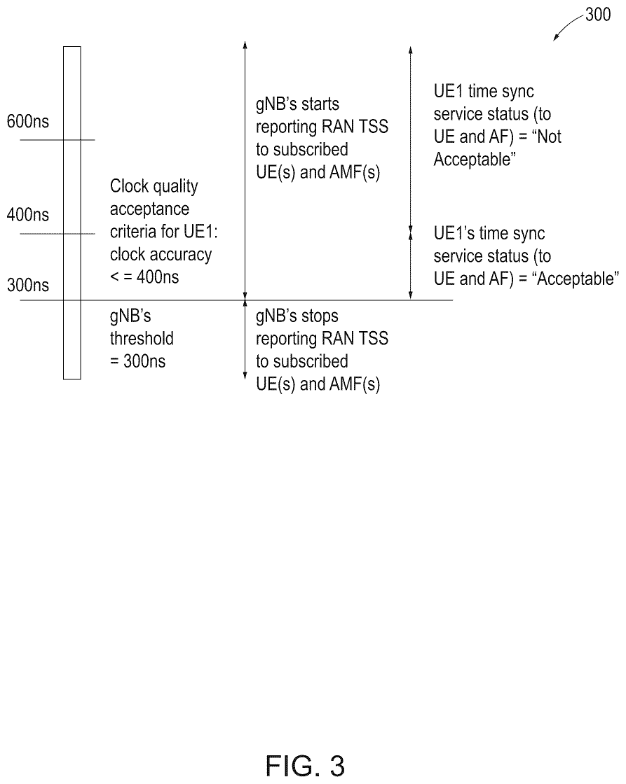

Turning now to FIG. 3, an illustration 300 is provided of a gNB's thresholds and a first user equipment's clock quality acceptance criteria for clock accuracy in accordance with previous embodiments. In FIG. 3, the gNB has a timing synchronization status threshold of 300 nanoseconds and the user equipment has a clock quality acceptance criteria of less than or equal to 400 nanoseconds. When clock accuracy is above 300 ns, the gNB reports radio access network timing synchronization status to subscribed user equipment and access and mobility management functions. When clock accuracy is below 300 nanoseconds, the gNB does not report radio access network timing synchronization status to subscribed user equipment and access and mobility management function. Between 300 nanoseconds and 400 nanoseconds, the first user equipment has a timing synchronization service status of “acceptable.” Greater than 400 nanoseconds, the first user equipment has a timing synchronization service status of “not acceptable.” In previous embodiments, the gNB reporting at the threshold of 300 ns does not properly capture the user equipment's clock quality acceptance criteria of 400 nanoseconds.

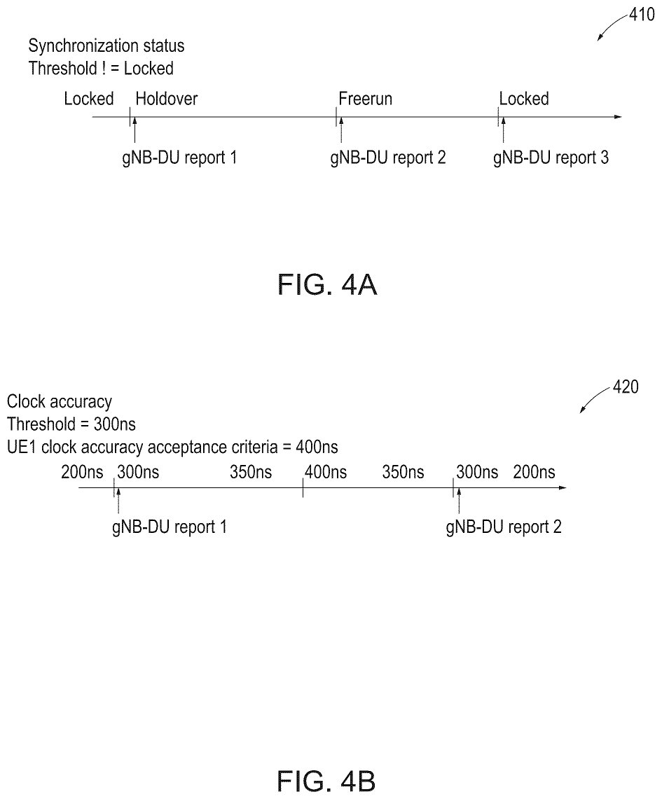

Turning now to FIG. 4A, an example 410 of event-triggered reporting in F1 application protocol is provided in accordance with previous embodiments. In one or more embodiments, the distributed unit gNB reports to the central unit gNB based on a pre-configured synchronization status threshold. In one or more embodiments, the distributed unit gNB reports when there is a change in the synchronization status value.

Turning now to FIG. 4B, an example 420 of event-triggered reporting in F1 application protocol is provided in accordance with previous embodiments. In one or more embodiments, the distributed unit of gNB reports to the central unit of gNB based on a pre-configured clock accuracy threshold. In one or more embodiments, the clock accuracy threshold for reporting is 300 nanoseconds. However, a user equipment has a clock accuracy acceptance criteria of 400 nanoseconds. In previous methods, there is no way to report when the user equipment clock accuracy acceptance criteria of 400 nanoseconds is met.

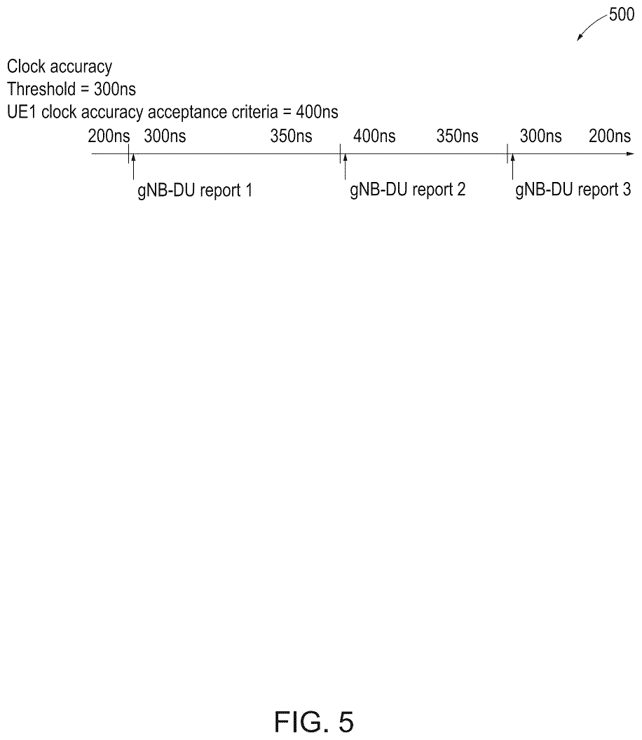

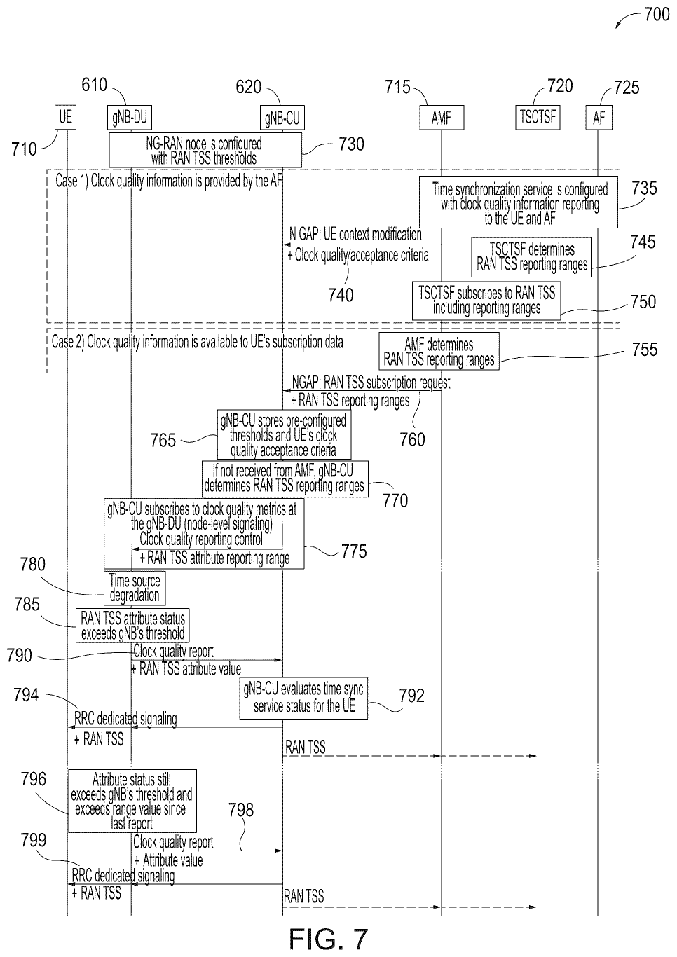

Turning now to FIG. 5 and reference to FIGS. 7 to 9, an example 500 of a method for next generation application protocol and F1 application protocol conditional event reporting is provided in accordance with an example embodiment. In one or more embodiments, conditional event reporting between a distributed unit of gNB 610, a central unit of gNB 620, and an access and mobility management function is provided. In one or more embodiments, the method supports radio access network timing synchronization status monitoring and reporting. In one or more embodiments, the distributed unit of gNB 610 transmits a report 510 when a threshold is exceeded. In one or more embodiments, when a threshold is exceeded, the distributed unit of gNB transmits a report 520 when a reporting range is exceeded on top of the threshold. In one or more embodiments, the distributed unit of gNB transmits a report 798 when the attribute (e.g., clock accuracy) falls below the threshold. Some examples of attributes are defined in 3GPP TS 23.501 as shown below.

TABLE 5.27.1.12-1
Information elements that gNB or UPF/NW-TT timing synchronization
status information may contain (all optional)

| Information Name | Description |
|---|---|
| Synchronization state | Indicates the state of the node synchronization, represented by the values |
| | “Locked”, “Holdover”, or “Freerun” (NOTE 1). |
| Clock quality | |
| >>Traceable to GNSS | Indicates whether the current time source is traceable to the GNSS and |
| | represented by values “Yes” or “No” |
| >>Traceable to UTC | Indicates whether the current time source is traceable to the UTC and |
| | represented by values “Yes” or “No” |
| >>Frequency stability | Describes the estimate of the variation of the local clock when it is not |
| | synchronized to another source (NOTE 2). |
| >>PTP clockClass | The attribute is defined in Table 5.28.3.1-2 and available under the assumption |
| | that the nodes is synchronized using (g)PTP. |
| >>Clock Accuracy | Describes the mean in ns over an ensemble of measurements of the time |
| | between the clock under test and a reference clock (NOTE 3) |
| Parent time source | Describes the primary source the node is currently using, represented by the |
| | values “PTP”, “GNSS”, “atomic clock”, “terrestrial radio”, “serial time code”, |
| | “NTP”, “hand_set”, “other”. |

(NOTE 1):
Clock is in the “Locked”, “Holdover”, or “Freerun” mode, as defined in ITU-T G.810 [164].
(NOTE 2):
Frequency stability is estimated in a similar manner as for offsetScaledLogVariance attribute defined in clause 7.6.3.5 of IEEE Std 1588 [126].
(NOTE 3):
Clock accuracy measurement considers accuracy up to gNB antenna and RAN internal process.

In one or more embodiments, for enumerated attributes in the RAN time synchronization status (e.g., synchronization state, traceable to coordinated universal time, traceable to global navigation satellite system, parent time source), the distributed unit of gNB 610 reports to the central unit of gNB 620 when there is a change in the enumerated value of the list, as shown in FIG. 4A. In one or more embodiments, this is done based on event-based reporting in F1 application protocol with the event “change on synchronization state” or another attribute. In one or more embodiments, this is done in next generation application protocol reporting between a central unit gNB and an access and mobility management function.

In one or more embodiments, for integer attributes in the radio access network timing synchronization status (e.g., clock accuracy, frequency stability) the distributed unit of gNB reports to the central unit of gNB when the integer value is above a threshold and there is a change beyond an additional enumerated report range value, as shown in report 520 of FIG. 5. In one or more embodiments, this method applies for F1 application protocol reporting. In one or more embodiments, this method applies for next generation application protocol reporting between a central unit of gNB 620 and an access and mobility management function 715. In one or more embodiments, a central unit of gNB 620 can request a step reporting to monitor the time synchronization status of the distributed unit of gNB. In one or more embodiments, conditional reporting can be determined using a clock accuracy acceptance criteria that a central unit of gNB has received from an access and mobility management function. For example, the clock accuracy threshold for reporting is 300 nanoseconds, while a first user equipment has a clock accuracy acceptance criteria of 400 nanoseconds and a second user equipment has a clock accuracy acceptance criteria of 450 nanoseconds. In this case, central unit of gNB 620 may determine the reporting range value to be a step value of 50 nanoseconds to enable the distributed unit of gNB 610 to transmit a report 520 for each increment in step value of 50 nanoseconds above the 300 nanosecond reporting threshold. In other embodiments, other step values may be determined and may be adjusted dynamically, depending on the user equipment types.

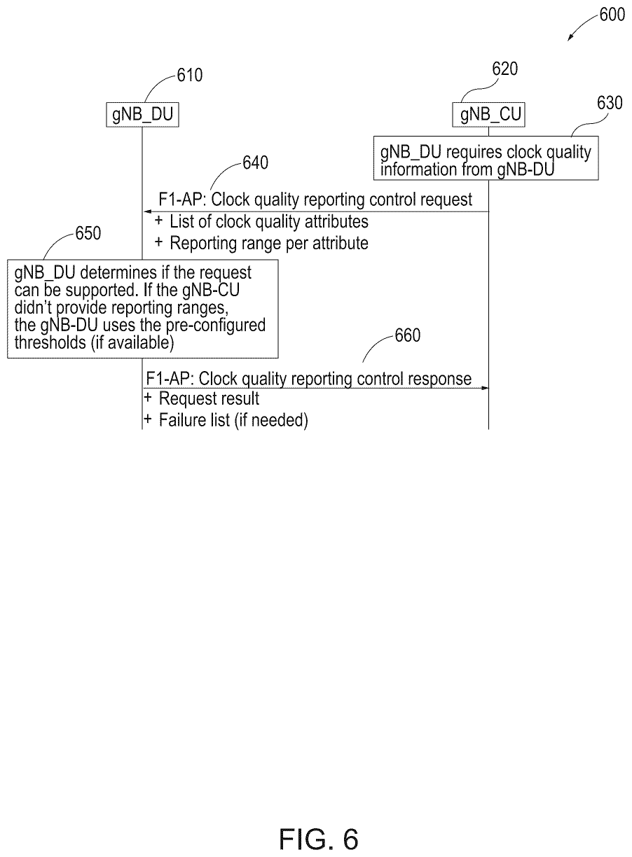

Turning now to FIG. 6, a flow diagram illustrating a F1 application protocol process 600 for clock quality control reporting is provided in accordance with an example embodiment. In one or more embodiments, at operation 630, the central unit of gNB 620 determines that it requires clock quality information from the distributed unit of gNB 610. In one or more embodiments, the central unit of gNB 630 determines a reporting range for a single clock quality attribute or multiple clock quality attributes. In one or more embodiments, the central unit of gNB 630 receives the reporting range or ranges from an access and mobility management function.

In one or more embodiments, at operation 640, the central unit of gNB 620 transmits a clock quality reporting control request to the distributed unit of gNB 610. In one or more embodiments, the request is transmitted in F1 application protocol. In one or more embodiments, the clock quality reporting control request comprises a list of clock quality attributes. In one or more embodiments, the event-based reporting available in the F1 application protocol and next generation application protocol is extended to add a condition for reporting while the event is active.

In one or more embodiments, the central unit the gNB 620 requests clock quality information from the distributed unit the gNB 610. In one or more embodiments, the request includes conditional event reporting provided by a reporting range for one or more clock quality attributes to the distributed unit the gNB 610.

In one or more embodiments, the clock quality reporting control request requires an additional reporting range information element. In one or more embodiments, the reporting range information element was provisioned per synchronization status attribute when an access and mobility management function sent a clock quality information subscription at a central unit the gNB 620 via next generation application protocol signaling. In one or more embodiments, the application function determined the reporting range based on knowledge of the time synchronization service requirements. In one or more embodiments, the application function included in its request for time synchronization with clock quality information a range for reporting the set of attributes of interest. In one or more embodiments, the reporting rang per attribute is sent from the time sensitive communication and time synchronization function to the central unit gNB 620 via an access and mobility management function to control the radio access node timing synchronization status reporting. In one or more embodiments, the application function determines what is interesting from a service perspective to be reported.

In one or more embodiments, the reporting range transmitted at operation 640 is adjusted to align with the attribute magnitude. In one or more embodiments, the reporting range may be defined depending on the acceptance criteria of user equipment 710 connected to distributed unit of gNB 610. In one or more embodiments, the reporting range for the radio access network timing synchronization status attribute comprises a quantization of the attribute. In one or more embodiments, linear quantization is used to determine the reporting range with the same quantization interval. In one or more embodiments, non-linear quantization is used to determine the reporting range. In one or more embodiments when non-linear quantization is used, quantization error changes with the clock accuracy range. In one or more embodiments, the central unit of gNB 620 configures the distributed unit of gNB 610 to report with quantization steps (e.g., the reporting range) of 50 nanoseconds in the range between 200 and 400 nanoseconds. In one or more embodiments, the central unit of gNB 620 configures the distributed unit gNB 610 to report with quantization steps (e.g., the reporting range) of 100 nanoseconds in the range is above 400 nanoseconds. In one or more embodiments, quantization is performed by defining a list of thresholds (e.g., intermediate thresholds for reporting). In one or more embodiments, a CHOICE structure for the report type is used. In one or more embodiments, a reporting event is defined for each threshold independently. In one or more embodiments, one F1 application protocol reporting configuration comprises one threshold. In one or more embodiments, where a reporting event is defined for each threshold independently, the central unit of gNB 620 provides multiple reporting at the distributed unit of gNB 610. In one or more embodiments, each reporting threshold comprises an identifier for management when the central unit of gNB 620 terminates the reporting. In one or more embodiments, each threshold requires a subscription between the nodes for managing the subscription independently.

In one or more embodiments, at operation 650, the distributed unit of gNB 610 determines whether a request can be supported. In one or more embodiments, the distributed unit of gNB 610 determines whether the received request is supported.

In one or more embodiments, the distributed unit of gNB 610 uses pre-configured thresholds to determine when to transmit a clock quality metrics to the central unit of the gNB 620. In one or more embodiments, the pre-configured thresholds are configured in the distributed unit of disaggregated gNB 610 in a situation when the reporting request is transmitted from central unit gNB 620. In other embodiments, the pre-configured thresholds are configured in the central unit of gNB 620 and the central unit provides the pre-configured threshold is a reporting configuration request message to the distributed unit of gNB.

In one or more embodiments, at operation 660, the distributed unit of gNB 610 transmits a clock quality reporting control response to the central unit of gNB 620. In one or more embodiments, the response is transmitted in F1 application protocol. In one or more embodiments, the response includes a request result. In one or more embodiments, the distributed unit of gNB indicates success or failure of the request. In one or more embodiments, the request is successful when the distributed unit of gNB 610 is capable of providing at least one of the attributes with one of the received conditional reporting thresholds or ranges. In one or more embodiments, the request is successful when the distributed unit gNB 610 is capable of providing at least one of the attributes based on a pre-configured threshold. In one or more embodiments, the response includes a failure list. In one or more embodiments, the failure list includes a list of attributes or conditions that the distributed unit gNB is unable to support.

Turning now to FIG. 7, a signal flow diagram illustrating a process 700 with conditional event reporting at the distributed unit of gNB is provided. In one or more embodiments, at operation 730, a next generation radio access node comprising a distributed unit of gNB 610 and a central unit of gNB 620 is configured with radio access network timing synchronization state thresholds.

In one or more embodiments where clock quality information is provided by the application function 725, the process 700 includes operations 735-750. In one or more embodiments, the time sensitive communication and time synchronization function 720 is responsible for determining the reporting range.

In one or more embodiments, at operation 735, an access and mobility management function 715, a time sensitive communication and time synchronization function 720, and an application function 725 are configured with clock quality information reporting. In one or more embodiment, the core network comprises a time synchronization service. In one or more embodiments, the clock quality information reporting is to the user equipment 710 and the application function 725.

In one or more embodiments, application function 725, time sensitive communication and time synchronization function 720, or access and mobility management function 715 are interested in receiving the timing synchronization status when the change in timing synchronization impacts the timing synchronization service for a user equipment 710 in a way that the service is provided in an acceptable or unacceptable level based on the user equipment's 710 clock quality acceptance criteria. In one or more embodiments, in this scenario, the time sensitive communication and time synchronization function 720 and the access and mobility management function 715 do not provide the timing synchronization status reporting ranges. In one or more embodiments, in this scenario, the central unit the gNB determines the timing synchronization status reporting ranges based on the clock quality acceptance criteria of all user equipment devices for which a clock quality acceptance criteria is configured (e.g., user equipment 710). In one or more embodiments, a radio access network timing synchronization status report towards the access and mobility management function 715 and the time sensitive communication and time synchronization function 720 may then be initiated when a clock quality changes from acceptable to unacceptable in a user equipment.

In one or more embodiments, at operation 740, clock quality acceptance criteria are transmitted from the access and mobility management function 715 to the central unit of gNB 620. In one or more embodiments, the clock quality acceptance criteria are transmitted with a user equipment context modification in next generation application protocol. In one or more embodiments, the clock quality acceptance criteria are transmitted with a user equipment context setup in next generation application protocol.

In one or more embodiments, at operation 745, the time sensitive communication and time synchronization function 720 determines the radio access network reporting ranges. In one or more embodiments, the time sensitive communication and time synchronization function 720 determines the radio access network reporting ranges based the application function's 725 requests for time synchronization service including clock quality reporting information.

In one or more embodiments, at operation 750, the time sensitive communication and time synchronization function 720 subscribes to radio access network timing synchronization status including reporting ranges. In one or more embodiments, the time sensitive communication and time synchronization function 720 provisions the reporting range to the access and mobility management function 715. In one or more embodiments, the time sensitive communication and time synchronization function 720 sends additional thresholds.

In one or more embodiments where clock quality information is available at the user equipment's 710 subscription data, the process 700 includes operation 755. In or more embodiments, the access and mobility management function 715 is responsible for determining the reporting ranges. In one or more embodiments, this is advantageous in that the application and mobility management function 715 has a wider view than the central unit of gNB 620 to consider the time synchronization service continuation across gNBs. In one or more embodiments, the access and mobility management function has an understanding of application request ranging from minimal acceptance threshold values for clock quality to the best possible values for clock quality. In one or more embodiments, it is useful for the access and mobility management function 715 to determine the radio access node time synchronization service ranges when mobility to a target cell can be conditioned to the synchronization status if multiple candidates are available.

In one or more embodiments, at operation 755, the access and mobility management function determines the radio access network reporting ranges. In one or more embodiments, the access and mobility management function determines the reporting ranges based on based on the time sensitive communication and time synchronization function 720 requests for time synchronization service including clock quality reporting information and user equipment 710 subscriptions.

In one or more embodiments, at operation 760, the access and mobility management function transmits the radio access network timing synchronization status reporting ranges to the central unit of gNB 620. In one or more embodiments, the radio access network timing synchronization service reporting ranges are transmitted to a central unit of gNB 620 with a next generation application protocol radio access network timing synchronization service subscription request. In one or more embodiments, the access and mobility management function 715 forwards the reporting ranges from the time sensitive communication and time synchronization function 720 to the central unit of gNB 620. In one or more embodiments, the access and mobility management function 715 modifies or complements thresholds received from the time sensitive communication and time synchronization function 720 when subscribing for receiving timing synchronization status with the information to the central unit of gNB 620. In one or more embodiments, the access and mobility management function 715 requests the central unit of gNB 620 conditional event reporting. In one or more embodiments, the central unit of gNB later requests the distributed unit of gNB reporting via F1 application protocol.

In one or more embodiments at operation 765, the central unit of gNB 620 stores pre-configured thresholds as well as clock quality acceptance criteria. In one or more embodiments, the clock quality acceptance criteria is associated with user equipment 710. In one or more embodiments, the central unit of gNB stores reporting ranges received from access and mobility management function 715.

In one or more embodiments, at operation 770, in a scenario where radio access network reporting ranges are not received from the access and mobility management function, the central unit of gNB determines radio access network timing synchronization service reporting ranges. In one or more embodiments, the central unit of gNB determines the radio access network timing synchronization status based on an access and mobility management function request for timing synchronization status and based on user equipment contexts (e.g., clock quality reporting information or clock quality acceptance criteria).

In one or more embodiments, at operation 775, the central unit of gNB 620 subscribes to clock quality metrics at the distributed unit of gNB 610. In one or more embodiments, operation 775 comprises node level signaling. In one or more embodiments, at operation 775, the central unit of gNB transmits the radio access network timing synchronization status attribute reporting ranges to the distributed unit of gNB. In one or more embodiments, the reporting ranges are transmitted with clock quality reporting control.

In one or more embodiments, at operation 780, time source degradation occurs at distributed of gNB 610.

In one or more embodiments, at operation 785, a radio access network timing synchronization status exceeds the distributed unit's threshold. In one or more embodiments, upon the timing synchronization status exceeding the threshold, the reporting range is monitored.

In one or more embodiments, at operation 790, the distributed unit of gNB 610 transmits a clock quality report to the central unit of gNB 620. In one or more embodiments, the clock quality report is transmitted in response to a radio access network timing synchronization status value being exceeded. In one or more embodiments, the clock quality report indicates the radio access network timing synchronization service attribute value for which the threshold was exceeded.

In one or more embodiments, at operation 792, the central unit of gNB 620 evaluates the time synchronization service status for the user equipment 710.

In one or more embodiments, at operation 794, the central unit of gNB 620 performs radio resource dedicated signaling to the user equipment 710. In one or more embodiments, the dedicated signaling indicates a radio access network timing synchronization status. In one or more embodiments, the central unit of gNB 620 signals the user equipment 710 through the distributed unit of gNB 610.

In one or more embodiments, at operation 796, the radio access network timing synchronization service reporting range is exceeded. In one or more embodiments, the radio access network reporting range is exceeded on top of the radio access network timing synchronization service threshold exceeded at operation 785.

In one or more embodiments, at operation 798, a clock quality report is transmitted to the central unit of gNB 610 from the distributed unit of gNB 610. In one or more embodiments, the clock quality report indicates that the radio access network timing synchronization service reporting range has been exceeded. In one or more embodiments, the clock quality report indicates the attribute value that was transmitted by the distributed unit of gNB 610.

In one or more embodiments, at operation 799, the central unit of gNB 620 performs radio resource dedicated signaling to the user equipment 710. In one or more embodiments, the dedicated signaling indicates a radio access network timing synchronization status. In one or more embodiments, the central unit of gNB 620 signals the user equipment 710 through the distributed unit of gNB 610.

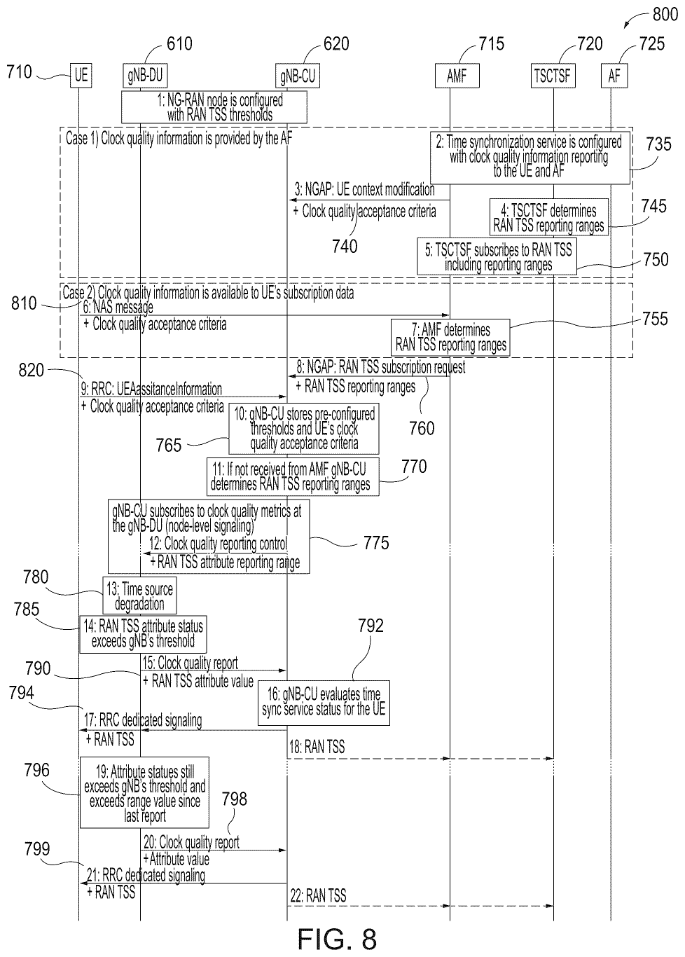

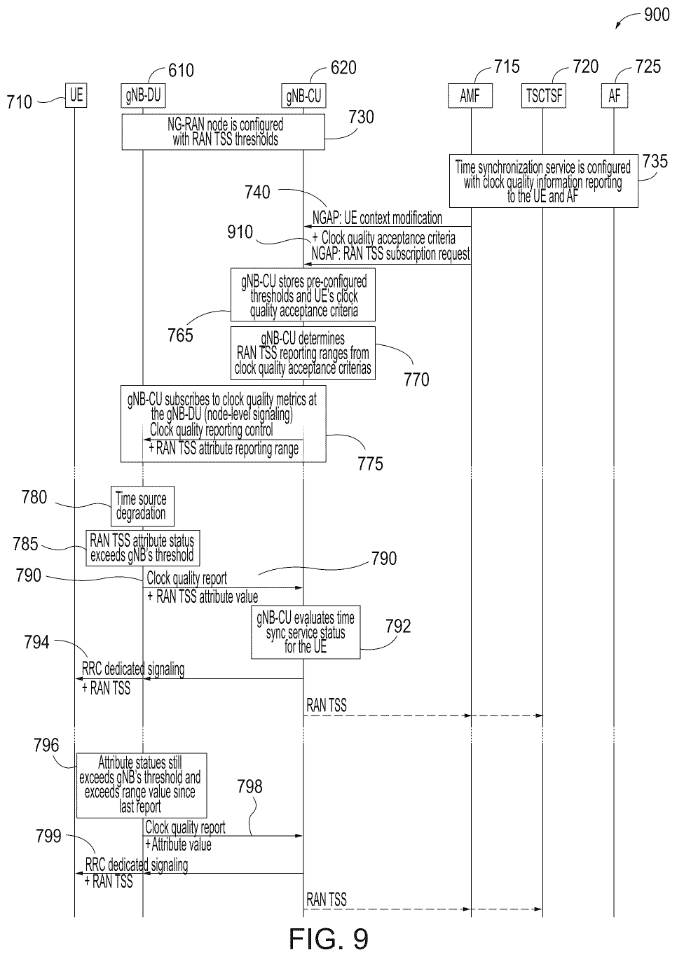

Turning now to FIG. 8, a signal flow diagram illustrating a process 800 with conditional event reporting at the distributed unit of gNB is provided. Some operations performed in both FIG. 7 and FIG. 9 are substantially similar and will not be described beyond the description provided above. Process 800 includes operations where the clock quality acceptance criteria is provided by user equipment 710.

In one or more embodiments, at operation 810, user equipment 710 provides a clock quality acceptance criteria to access and mobility management function 715. In one or more embodiments, the clock quality acceptance criteria is later forwarded to the central unit of gNB 620 at operation 760. In one or more embodiments, the clock quality control acceptance criteria is transmitted in a non access stratum message. In one or more embodiments, the non access stratum message comprises a non access stratum registration request. In one or more embodiments, the non access stratum message comprises an uplink non access stratum transport.

In one or more embodiments, at operation 820, the user equipment 710 provides a clock quality acceptance criteria to central unit of gNB 620. In one or more embodiments, the clock quality acceptance criteria is provided over radio resource control. In one or more embodiments, the message is a UEAssistanceInformation message.

Turning now to FIG. 9, a signal flow diagram illustrating a process 900 with determination of timing synchronization status reporting ranges based on acceptance criteria is provided. In one or more embodiments, application function 725, time sensitive communication and time synchronization function 720, or access and mobility management function 715 are interested in receiving the timing synchronization status when the change in timing synchronization impacts the timing synchronization service for a user equipment 710 in a way that the service is provided in an acceptable or unacceptable level based on the user equipment's 710 clock quality acceptance criteria. In one or more embodiments, in this scenario, the time sensitive communication and time synchronization function 720 and the access and mobility management function 715 do not provide the timing synchronization status reporting ranges. In one or more embodiments, in this scenario, the central unit of gNB determines the timing synchronization status reporting ranges based on the clock quality acceptance criteria of all user equipment devices for which a clock quality acceptance criteria is configured (e.g., user equipment 710). In one or more embodiments, a radio access network timing synchronization status report towards the access and mobility management function 715 and the time sensitive communication and time synchronization function 720 may then be initiated when a clock quality changes from acceptable to unacceptable for a user equipment.

Some operations performed in both FIG. 7 and FIG. 9 are substantially similar and will not be described beyond the description provided above. Process 900 describes a case where the central unit of gNB determines the radio access network timing synchronization status reporting ranges. In one or more embodiments, at operation 910, access and mobility management function 715 transmits a radio access network timing synchronization status subscription request to central unit of gNB 620. In one or more embodiments, the radio access network timing synchronization status subscription request is transmitted in next generation application protocol. In one or more embodiments, at operation 770, the central unit of gNB determines the radio access network timing synchronization service reporting ranges based on the radio access network timing synchronization subscription request received at operation 910. In one or more embodiments, at operation 770, the central unit of gNB determines the radio access network timing synchronization service reporting ranges based on the clock quality acceptance criteria received at operation 740.

In one or more embodiments, a central unit of gNB 620 influences a distributed unit's 610 pre-configured threshold based on clock quality acceptance criteria. In one or more embodiments, central and distributed unit of gNB 620 and 610 have thresholds configured for radio access network timing synchronization status reporting (e.g., clock accuracy of 200 nanoseconds). In one or more embodiments, the central unit of gNB 620 receives user equipment context from access and mobility management function 715 with a clock quality acceptance criteria (e.g., clock accuracy of 300 nanoseconds). In one or more embodiments, the central unit of gNB 620 determines that there is no user equipment context that uses a value as low as the preconfigured threshold (e.g., all user equipment devices have clock quality acceptance criteria above 300 nanoseconds). In one or more embodiments, the central unit of gNB 620 sends a command to the distributed unit of gNB 610 to monitor an additional threshold comprising a reporting range for clock accuracy (e.g., update to 300 nanoseconds). In one or more embodiments, the additional threshold is sent when the central unit of gNB requests the subscription for radio access network timing synchronization service at operation 775. In one or more embodiments, the additional threshold is part of a new F1 application protocol procedure. In one or more embodiments, there is a different signaling in F1 application protocol than next generation application protocol in that the access and mobility management function 715 does not provide thresholds to the central unit of gNB. In one or more embodiments, adding a threshold will impact reporting towards user equipment devices and the time sensitive communication and time synchronization function 720. In one or more embodiments, the central unit of gNB sends a reporting range when it can ensure active subscriptions to status updates won't be neglected.

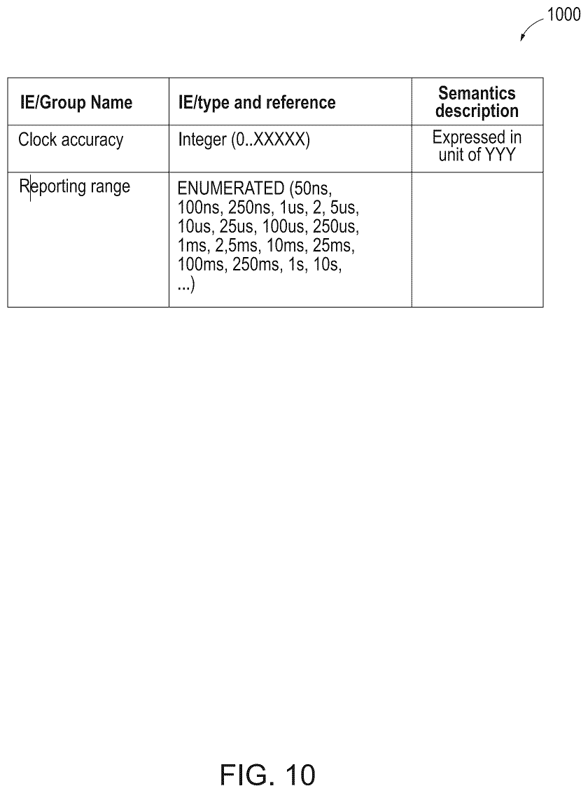

Turning now to FIG. 10, a table 1000 is provided illustrating an integer encoding of a radio access network timing synchronization attribute in accordance with an example embodiment. In one or more embodiments, the table 1000 is an integer encoding of clock accuracy. In one or more embodiment, the list of threshold values can be stored in a central unit of gNB for next generation application protocol reporting towards an access and mobility management function. In one or more embodiments, an additional threshold is provided as a threshold relative to a previous report. For example, if a last reported clock accuracy comprises 400 nanoseconds, and the reporting range is 100 nanoseconds, the distributed unit of gNB will generate the next report when the clock accuracy changes to 300 nanoseconds or 500 nanoseconds. In one or more embodiments, clock accuracy F1 application protocol reporting is configured at the distributed unit of gNB. In one or more embodiments, next generation application protocol reporting is configured at the central unit of gNB.

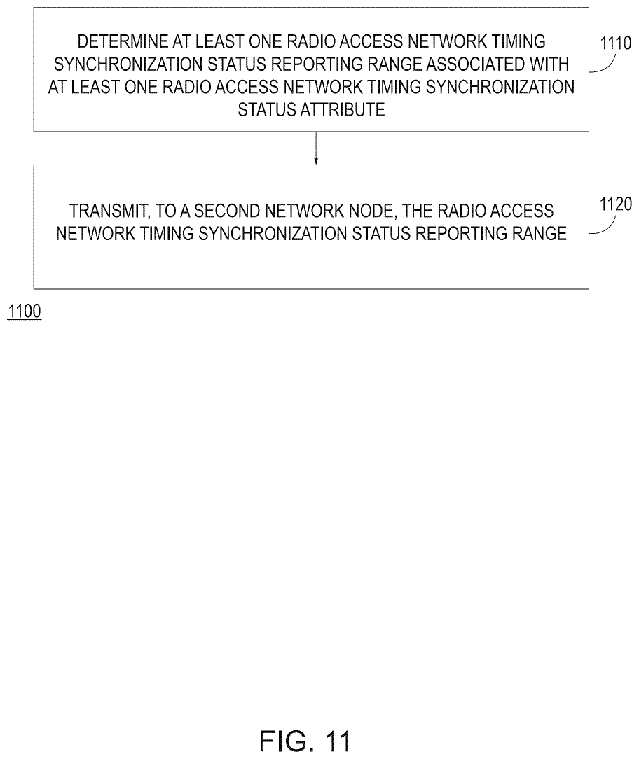

Turning now to FIG. 11, an example flowchart is illustrated for a process 1100 for an apparatus embodied by a network entity 620 to transmit radio access network timing synchronization status reporting ranges.

As shown in block 1110 of FIG. 11, the apparatus embodied by the network entity 620 includes means, such as the processing circuitry 220, the communication interface 260, or the like, for determining at least one radio access network timing synchronization status reporting range associated with at least one radio access network timing synchronization status attribute. In one or more embodiments, the at least one radio access network timing synchronization status reporting range is determined based on the timing synchronization status threshold. In one or more embodiments, the at least one radio access network timing synchronization status reporting range is determined based on at least one user equipment clock quality acceptance criteria. In one or more embodiments, the at least one user equipment clock quality acceptance criteria is received from a user equipment (710). In one or more embodiments, the at least one user equipment clock quality acceptance criteria is received over radio resource control. In one or more embodiments, the at least one user equipment clock quality acceptance criteria is received from a core network node. In one or more embodiments, the at least one radio access network timing synchronization reporting range is determined based on a plurality of user equipment clock quality acceptance criteria. In one or more embodiments, the at least one radio access network timing synchronization status reporting range is received from a core network node (715/720). In one or more embodiments, the core network node (715) comprises at least one or both of: an access and mobility management function (AMF) (715) and a time sensitive communication and time synchronization function (TSCTSF) (720). In one or more embodiments, the time sensitive communication and time synchronization function (720) determines the radio access network timing synchronization status reporting range and subscribes to the access and mobility management function (715) for at least one radio access network timing synchronization status (RAN TSS). In one or more embodiments, the access and mobility management function (715) is configured to pass the at least one radio access network timing synchronization status reporting range provided by the time sensitive communication and time synchronization function (720) when the at least one user equipment clock quality acceptance criteria is not present. In one or more embodiments, the at least one radio access network timing synchronization status reporting range comprises a plurality of radio access network timing synchronization status reporting ranges associated with a plurality of radio access network timing synchronization status attributes.

As shown in block 1120 of FIG. 11, the apparatus embodied by the network entity 620 includes means, such as the processing circuitry 220, the communication interface 260, or the like, for transmitting, to a second network node (610), the radio access network timing synchronization status reporting range. In one or more embodiments, the network entity 620 further includes means, such as the processing circuitry 220, the communication interface 260, or the like, for receiving, from the second network node (610), a radio access network timing synchronization status report when a timing synchronization status threshold and the radio access network timing synchronization status reporting range are satisfied.

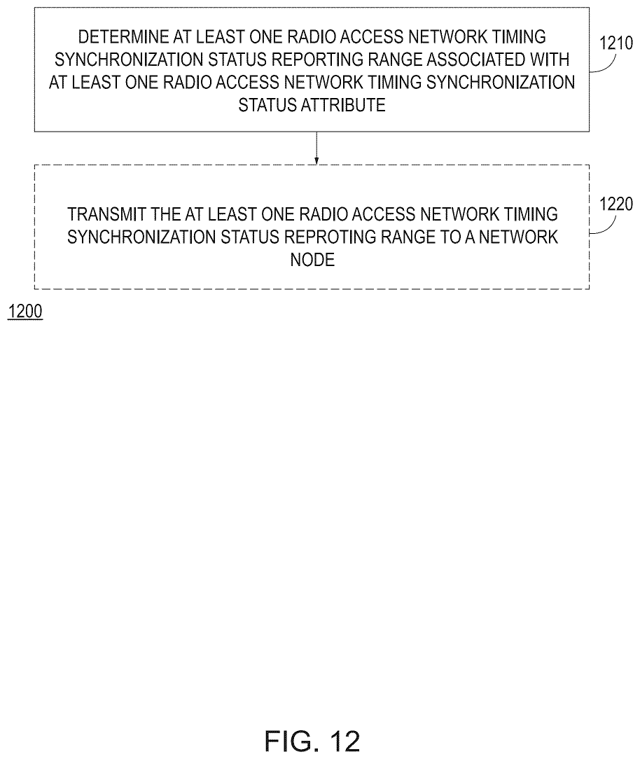

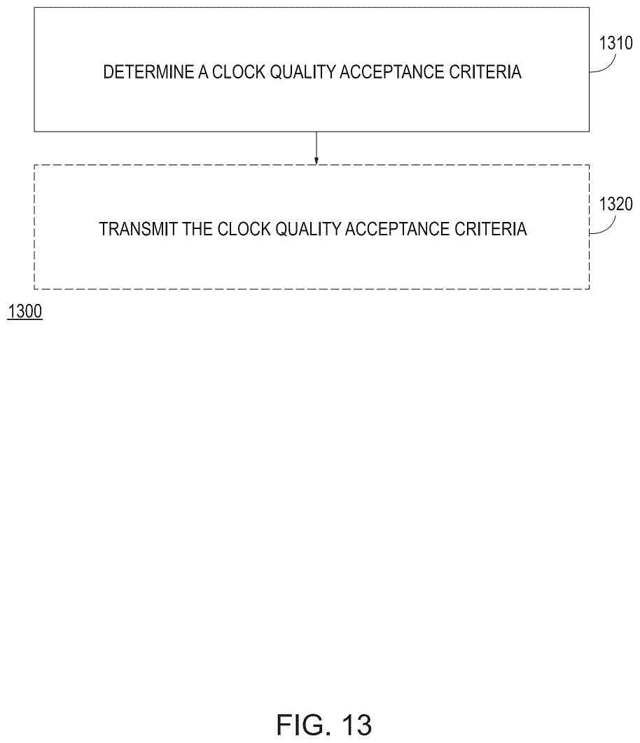

Turning now to FIG. 12, an example flowchart is illustrated for a process 1200 for an apparatus embodied by a core network entity 715/720 to determine radio access network timing synchronization status reporting ranges.

As shown in block 1210 of FIG. 12, the apparatus embodied by the core network entity 715/720 includes means, such as the processing circuitry 220, the communication interface 260, or the like, for determining at least one radio access network timing synchronization status reporting range associated with at least one radio access network timing synchronization status attribute. In one or more embodiments, the core network node (720) comprises at least one or both of: an access and mobility management function (AMF) (715) and a time sensitive communication and time synchronization function (TSCTSF) (720). In one or more embodiments, the at least one radio access network timing synchronization status reporting range is determined based on at least one user equipment clock quality acceptance criteria. In one or more embodiments, the at least one clock quality acceptance criteria comprises a plurality of clock quality acceptance criteria. In one or more embodiments, the at least one clock quality acceptance criteria is received from at least one user equipment. In one or more embodiments, the time sensitive communication and time synchronization function (720) determines the radio access network timing synchronization status reporting range and subscribes to the access and mobility management function (715) for at least one radio access network timing synchronization (RAN TSS). In one or more embodiments, the access and mobility management function (715) is configured to pass the at least one radio access network timing synchronization status reporting range provided by the time sensitive communication and time synchronization function (720) when the at least one user equipment clock quality acceptance criteria is not present. In one or more embodiments, the at least one clock quality acceptance criteria is received through a non access stratum message. In one or more embodiments, the non access stratum message comprises a non access stratum registration request. In one or more embodiments, the non access stratum message comprises an uplink non access stratum transport.

As shown in block 1220 of FIG. 12, the apparatus embodied by the core network entity 715/720 includes means, such as the processing circuitry 220, the communication interface 260, or the like, for transmitting the at least one radio access network timing synchronization status reporting range to a network node (620).

Turning now to FIG. 13, an example flowchart is illustrated for a process 1300 for an apparatus embodied by a user equipment 710 to transmit clock quality acceptance criteria.

As shown in block 1310 of FIG. 13, the apparatus embodied by the user equipment 710 includes means, such as the processing circuitry 220, the communication interface 260, or the like, for determining a clock quality acceptance criteria.

As shown in block 1320 of FIG. 13, the apparatus embodied by the user equipment 710 includes means, such as the processing circuitry 220, the communication interface 260, or the like, for determining a clock quality acceptance criteria. In one or more embodiments, the clock quality acceptance criteria is transmitted to a core network node (715). In one or more embodiments, the clock quality acceptance criteria is transmitted through a non access stratum message. In one or more embodiments, the non access stratum message comprises a non access stratum registration request. In one or more embodiments, the non access stratum message comprises an uplink non access stratum transport. In one or more embodiments, the clock quality acceptance criteria is transmitted to a network node (620). In one or more embodiments, the clock quality acceptance criteria is transmitted over radio resource control.

FIGS. 11-13 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 240 of an apparatus employing an embodiment and executed by a processor 220. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In one or more embodiments, a network node (620) is provided, including at least one processor and at least one memory storing instructions that, when executed by the at least one processor, cause the network node (620) to determine at least one radio access network timing synchronization status reporting range associated with at least one radio access network timing synchronization status attribute and transmit, to a second network node (610), the radio access network timing synchronization status reporting range.

In one or more embodiments, the at least one memory and the computer program code are further configured to, with the at least one processor, cause the network node (620) to receive, from the second network node (610), a radio access network timing synchronization status report when a timing synchronization status threshold and the radio access network timing synchronization status reporting range are satisfied.

In one or more embodiments, the at least one radio access network timing synchronization status reporting range is determined based on the timing synchronization status threshold.

In one or more embodiments, the at least one radio access network timing synchronization status reporting range is determined based on at least one user equipment clock quality acceptance criteria.

In one or more embodiments, the at least one radio access network timing synchronization status reporting range comprises a step value, wherein the network node (130) receives the radio access network timing synchronization status report when the timing synchronization status threshold is exceeded by an integer multiple of the step value.

In one or more embodiments, the at least one user equipment clock quality acceptance criteria is received from a user equipment (710).

In one or more embodiments, the at least one user equipment clock quality acceptance criteria is received over radio resource control.

In one or more embodiments, the at least one user equipment clock quality acceptance criteria is received from a core network node.

In one or more embodiments, the at least one radio access network timing synchronization reporting range is determined based on a plurality of user equipment clock quality acceptance criteria.

In one or more embodiments, the at least one radio access network timing synchronization status reporting range is received from a core network node (715/720).

In one or more embodiments, the core network node (715/720) includes at least one or both of: an access and mobility management function (AMF) and a time sensitive communication and time synchronization function (TSCTSF).

In one or more embodiments, the time sensitive communication and time synchronization function determines the radio access network timing synchronization status reporting range and subscribes to the access and mobility management function for at least one radio access network timing synchronization status (RAN TSS). [745/750]

In one or more embodiments, the access and mobility management function is configured to pass the at least one radio access network timing synchronization status reporting range provided by the time sensitive communication and time synchronization function when the at least one user equipment clock quality acceptance criteria is not present. [750/760]

In one or more embodiments, the at least one radio access network timing synchronization status reporting range includes a plurality of radio access network timing synchronization status reporting ranges associated with a plurality of radio access network timing synchronization status attributes.

In one or more embodiments, a core network node (715/720) is provided, including at least one processor and at least one memory storing instructions that, when executed by the at least one processor, cause the core network node (715/720) to determine at least one radio access network timing synchronization status reporting range associated with at least one radio access network timing synchronization status attribute. [745/755]

In one or more embodiments, the at least one memory and the computer program code are further configured to, with the at least one processor, cause the core network node (715/720) to transmit the at least one radio access network timing synchronization status reporting range to a network node (620).

In one or more embodiments, the core network node (720) includes at least one or both of: an access and mobility management function (AMF) (715) and a time sensitive communication and time synchronization function (TSCTSF) (720).

In one or more embodiments, the at least one radio access network timing synchronization status reporting range is determined based on at least one user equipment clock quality acceptance criteria.

In one or more embodiments, the at least one clock quality acceptance criteria includes a plurality of clock quality acceptance criteria.

In one or more embodiments, the at least one clock quality acceptance criteria is received from at least one user equipment.

In one or more embodiments, the time sensitive communication and time synchronization function (720) determines the radio access network timing synchronization status reporting range and subscribes to the access and mobility management function (715) for at least one radio access network timing synchronization (RAN TSS).

In one or more embodiments, the access and mobility management function (715) is configured to pass the at least one radio access network timing synchronization status reporting range provided by the time sensitive communication and time synchronization function (720) when the at least one user equipment clock quality acceptance criteria is not present.

In one or more embodiments, the at least one clock quality acceptance criteria is received through a non access stratum message.

In one or more embodiments, the non access stratum message includes a non access stratum registration request.

In one or more embodiments, the non access stratum message includes an uplink non access stratum transport.

In one or more embodiments, a user equipment (710) is provided, including at least one processor and at least one memory storing instructions that, when executed by the at least one processor, cause the user equipment (710) to determine a clock quality acceptance criteria and transmit the clock quality acceptance criteria. [810/820]

In one or more embodiments, the clock quality acceptance criteria is transmitted to a core network node (715).

In one or more embodiments, the clock quality acceptance criteria is transmitted through a non access stratum message.

In one or more embodiments, the non access stratum message includes a non access stratum registration request.

In one or more embodiments, the non access stratum message includes an uplink non access stratum transport.

In one or more embodiments, the clock quality acceptance criteria is transmitted to a network node (620).

In one or more embodiments, the clock quality acceptance criteria is transmitted over radio resource control.

In one or more embodiments, a network node is provided, including means for determining at least one radio access network timing synchronization status reporting range associated with at least one radio access network timing synchronization status attribute and means for transmitting, to a second network node, the radio access network timing synchronization status reporting range.

In one or more embodiments, the network node further includes means for receiving, from the second network node, a radio access network timing synchronization status report when a timing synchronization status threshold and the radio access network timing synchronization status reporting range are satisfied.

In one or more embodiments, the at least one radio access network timing synchronization status reporting range is determined based on the timing synchronization status threshold.

In one or more embodiments, the at least one radio access network timing synchronization status reporting range is determined based on at least one user equipment clock quality acceptance criteria.

In one or more embodiments, the at least one radio access network timing synchronization status reporting range comprises a step value, wherein the network node receives the radio access network timing synchronization status report when the timing synchronization status threshold is exceeded by an integer multiple of the step value.

In one or more embodiments, the at least one user equipment clock quality acceptance criteria is received from a user equipment.

In one or more embodiments, the at least one user equipment clock quality acceptance criteria is received over radio resource control.

In one or more embodiments, the at least one user equipment clock quality acceptance criteria is received from a core network node.

In one or more embodiments, the at least one radio access network timing synchronization reporting range is determined based on a plurality of user equipment clock quality acceptance criteria.

In one or more embodiments, the at least one radio access network timing synchronization status reporting range is received from a core network node.

In one or more embodiments, the core network node includes at least one or both of: an access and mobility management function (AMF) and a time sensitive communication and time synchronization function (TSCTSF).

In one or more embodiments, the time sensitive communication and time synchronization function determines the radio access network timing synchronization status reporting range and subscribes to the access and mobility management function for at least one radio access network timing synchronization status (RAN TSS).

In one or more embodiments, the access and mobility management function is configured to pass the at least one radio access network timing synchronization status reporting range provided by the time sensitive communication and time synchronization function when the at least one user equipment clock quality acceptance criteria is not present.

In one or more embodiments, the at least one radio access network timing synchronization status reporting range includes a plurality of radio access network timing synchronization status reporting ranges associated with a plurality of radio access network timing synchronization status attributes.

In one or more embodiments, a core network node is provided, including means for determining at least one radio access network timing synchronization status reporting range associated with at least one radio access network timing synchronization status attribute.

In one or more embodiments, the core network node further includes means for transmitting the at least one radio access network timing synchronization status reporting range to a network node.

In one or more embodiments, the core network node includes at least one or both of: an access and mobility management function (AMF) and a time sensitive communication and time synchronization function (TSCTSF).

In one or more embodiments, the at least one radio access network timing synchronization status reporting range is determined based on at least one user equipment clock quality acceptance criteria.

In one or more embodiments, the at least one clock quality acceptance criteria includes a plurality of clock quality acceptance criteria.

In one or more embodiments, the at least one clock quality acceptance criteria is received from at least one user equipment.

In one or more embodiments, the time sensitive communication and time synchronization function determines the radio access network timing synchronization status reporting range and subscribes to the access and mobility management function for at least one radio access network timing synchronization (RAN TSS).

In one or more embodiments, the access and mobility management function is configured to pass the at least one radio access network timing synchronization status reporting range provided by the time sensitive communication and time synchronization function when the at least one user equipment clock quality acceptance criteria is not present.

In one or more embodiments, the at least one clock quality acceptance criteria is received through a non access stratum message.

In one or more embodiments, the non access stratum message includes a non access stratum registration request.

In one or more embodiments, the non access stratum message includes an uplink non access stratum transport.

In one or more embodiments, a user equipment is provided, including means for determining, a clock quality acceptance criteria and means for transmitting the clock quality acceptance criteria.

In one or more embodiments, the clock quality acceptance criteria is transmitted to a core network node.

In one or more embodiments, the clock quality acceptance criteria is transmitted through a non access stratum message.

In one or more embodiments, the non access stratum message includes a non access stratum registration request.

In one or more embodiments, the non access stratum message includes an uplink non access stratum transport.

In one or more embodiments, the clock quality acceptance criteria is transmitted to a network node.

In one or more embodiments, the clock quality acceptance criteria is transmitted over radio resource control.

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A network node, comprising:
at least one processor; and
at least one memory storing instructions that, when executed by the at least one processor, cause the network node to perform:
determine at least one radio access network timing synchronization status reporting range associated with at least one radio access network timing synchronization status attribute; and
transmit, to a second network node, the radio access network timing synchronization status reporting range.

2. The network node of claim 1, wherein the at least one memory and the computer program code are further configured to, with the at least one processor, cause the network node to:
receive, from the second network node, a radio access network timing synchronization status report when a timing synchronization status threshold and the radio access network timing synchronization status reporting range are satisfied.

3. The network node of claim 1, wherein the at least one radio access network timing synchronization status reporting range is determined based on the timing synchronization status threshold.

4. The network node of claim 1, wherein the at least one radio access network timing synchronization status reporting range is determined based on at least one user equipment clock quality acceptance criteria.

5. The network node of claim 2, wherein the at least one radio access network timing synchronization status reporting range comprises a step value, wherein the network node receives the radio access network timing synchronization status report when the timing synchronization status threshold is exceeded by an integer multiple of the step value.

6. The network node of claim 4, wherein the at least one user equipment clock quality acceptance criteria is received through at least one of:
from a user equipment;
over radio resource control; or
from a core network node.

7. The network node of claim 1, wherein the at least one radio access network timing synchronization reporting range is determined based on a plurality of user equipment clock quality acceptance criteria.

8. The network node of claim 1, wherein the at least one radio access network timing synchronization status reporting range is received from a core network node.

9. The network node of claim 8, wherein the core network node comprises at least one or both of: an access and mobility management function (AMF) and a time sensitive communication and time synchronization function (TSCTSF).

10. The network node of claim 9, wherein the time sensitive communication and time synchronization function determines the radio access network timing synchronization status reporting range and subscribes to the access and mobility management function for at least one radio access network timing synchronization status (RAN TSS).

11. The network node of claim 10, wherein the access and mobility management function is configured to pass the at least one radio access network timing synchronization status reporting range provided by the time sensitive communication and time synchronization function when the at least one user equipment clock quality acceptance criteria is not present.

12. The network node of claim 1, wherein the at least one radio access network timing synchronization status reporting range comprises a plurality of radio access network timing synchronization status reporting ranges associated with a plurality of radio access network timing synchronization status attributes.

13. A core network node, comprising:
at least one processor; and
at least one memory storing instructions that, when executed by the at least one processor, cause the core network node to perform:
determine at least one radio access network timing synchronization status reporting range associated with at least one radio access network timing synchronization status attribute.

14. The core network node of claim 13, wherein the at least one memory and the computer program code are further configured to, with the at least one processor, cause the core network node to:
transmit the at least one radio access network timing synchronization status reporting range to a network node.

15. The core network node of claim 13, wherein the at least one radio access network timing synchronization status reporting range is determined based on at least one user equipment clock quality acceptance criteria, wherein the at least one clock quality acceptance criteria comprises a plurality of clock quality acceptance criteria, or is received from at least one user equipment.

16. The core network node of claim 15, wherein the at least one clock quality acceptance criteria is received through a non access stratum message, and the non access stratum message comprises at least one of:
a non access stratum registration request; and
an uplink non access stratum transport.

17. A user equipment, comprising:
at least one processor; and
at least one memory storing instructions that, when executed by the at least one processor, cause the user equipment to perform:
determine a clock quality acceptance criteria; and
transmit the clock quality acceptance criteria.

18. The user equipment of claim 17, wherein the clock quality acceptance criteria is transmitted to a core network node or through a non access stratum message.

19. The user equipment of claim 18, wherein the non access stratum message comprises at least one of: a non access stratum registration request or an uplink non access stratum transport.

20. The user equipment of claim 17, wherein the clock quality acceptance criteria is transmitted to a network node or transmitted over radio resource control.
